(19) United States
(12) Patent Application Publication
(10) Pub. No.: US 2026/0228001 A1
(43) Pub. Date: Aug. 6, 2026

(54) APPARATUS AND METHOD FOR PROCESSING 4-BIT FLOATING-POINT INPUTS USING SCALED 5-BIT INTEGERS FOR ARTIFICIAL INTELLIGENCE (AI) WORKLOADS

(71) Applicant: Intel Corporation, Santa Clara, CA (US)

(72) Inventors: Chuanjun Zhang, Devon, PA (US); Matthew Adiletta, Bolton, MA (US); Simon C. Steely, Jr., Hudson, NH (US)

(73) Assignee: Intel Corporation, Santa Clara, CA (US)

(21) Appl. No.: 19/632,160

(22) Filed: Mar. 27, 2026

(51) Int. Cl. G06F 9/30

(52) U.S. Cl. CPC G06F 9/3001; G06F 9/3013; G06F 9/30145

(57) ABSTRACT

Apparatus and method for scaled integer 5-bit based FP 4 processing. For example, a method comprises: loading a plurality of source 4-bit floating-point (FP4) data elements in one or more registers; determining pairs of INT5 scalar values, INT5 bases, and INT5 signs corresponding to pairs of the source FP4 data elements; performing decoding of each pair of INT5 scalar values in accordance with a map comprising a reduced set of logic gates configured to map each INT5 scalar value directly to generate a corresponding INT5 scalar result; multiplying each corresponding pair of INT5 bases circuitry to generate a base product; generating a two's complement representation of the base product, the two's complement representation comprising a plurality of result bits; and selecting, by a multiplexor network, a set of the result bits based on the corresponding INT5 scalar result, the set of the result bits comprising a dot-product result.

### BACKGROUND

### Field of the Invention

Embodiments of this disclosure relate generally to the field of computer processors. More particularly, the embodiments relate to an apparatus and method for processing 4-bit floating-point inputs using scaled 5-bit integers for AI applications.

### Description of Related Art

Current large language model (LLM) training and inference engine designs rely on 4-bit floating point (e.g., FP4-E2M1) dot products with block scaling. These data formats are important optimizations for memory footprint reductions and core machine-learning compute density as well as power and performance efficiency.

### BRIEF DESCRIPTION OF THE DRAWINGS

A better understanding of the present invention can be obtained from the following detailed description in conjunction with the following drawings, in which:

FIG. 1 illustrates information associated with the conversion of FP4 values to scaled INT5 values in accordance with some embodiments.

FIG. 2 illustrates an example of circuitry for performing an FP4 dot product using a conversion to INT5.

FIG. 3A illustrates another example of circuitry for performing an FP4 dot product with reduced logic using Karnaugh maps (K-maps).

FIG. 3B illustrates two's complement logic applied to INT5 base values in accordance with some embodiments.

FIG. 3C illustrates a multiplexor (MUX) logic table for generating each output bit of a dot-product.

FIG. 4 illustrates a processor pipeline in accordance with some embodiments.

FIG. 5 illustrates a method in accordance with some embodiments of this disclosure.

### DETAILED DESCRIPTION

Embodiments of this disclosure include mechanisms for converting 4-bit floating-point values into scaled 5-bit signed integers by multiplying the FP4 values (e.g., in E2M1 format: 1 sign bit, 2 exponent bits and 1 mantissa bit) by 2. Each FP4 value is converted into a 5-bit integer having three components: a 1-bit sign, a 2-bit scalar value, and a 2-bit integer value. In accordance with some implementations, the multiplication of two 5-bit integers is transformed into the multiplication of the scalar values and the 2-bit integer values. Significantly, a direct computation can be performed with the scalar values since the scalar product has only five possible values: 1, 2, 4, 8, and 16, eliminating the requirement of arithmetic circuitry (e.g., multipliers and adders). Additionally, in some embodiments, barrel shifters are replaced with precisely configured multiplexor networks to further reduce area and power consumption.

In the following description, for the purposes of explanation, numerous specific details are set forth to provide a thorough understanding of the embodiments of the invention described below. It will be apparent, however, to one skilled in the art that the embodiments of the invention may be practiced without some of these specific details. For example, while embodiments are described herein using E2M1 4-bit floating-point source values, the underlying principles described herein may be applied to various other source data formats, such as NF4, FP8, and INT4. In various embodiments described below, well-known structures and devices are shown in block diagram form to avoid obscuring the underlying principles of the embodiments of the invention.

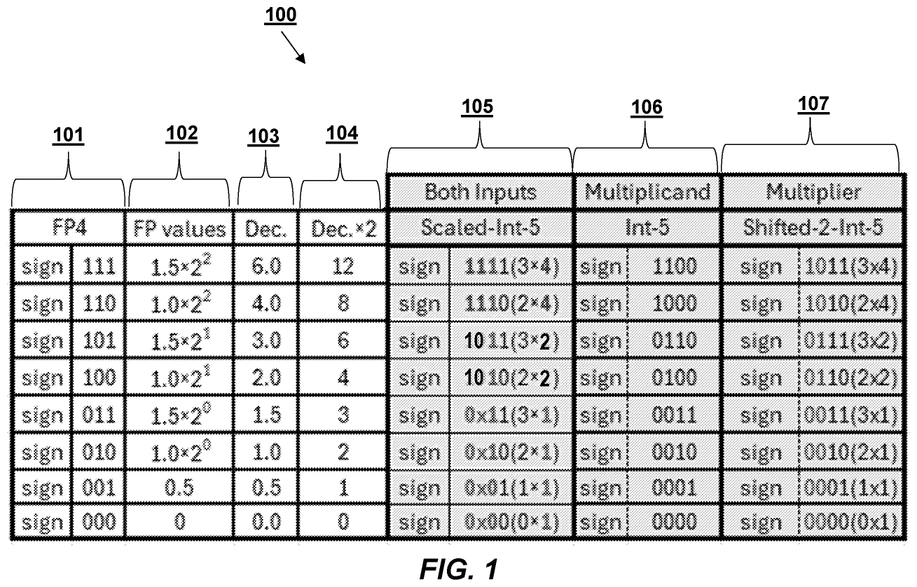

The E2M1 format of FP4, used in LLM training and inference, is defined in the OCP Microscaling format specifications, as will be described with respect to the table 100 in FIG. 1. The leftmost column 101 presents the E2M1 format of FP4, which consists of one sign bit and three data bits. These data bits include a 2-bit exponent with a bias of 1 and one mantissa bit. It is important to note that there is an implicit 1 for the mantissa, resulting in two mantissa bits for normal values.

The second column 102, labeled “FP values,” displays the positive FP4 values in floating-point format. The third column 103 shows these values in decimal format. Among these, only two positive values are non-integers: 1.5 and 0.5. Based on this observation, FP4 values can be converted into integers by multiplying them by two, which transforms all values into integers, as shown in the “Dec.×2” column 104.

Thus, a scaled-INT5 value can be used which decomposes the values into a scalar multiplied by an integer, as indicated in column 105 (e.g., 1111 can be represented as 3×4=12; 1011 can be represented as 3×2, etc.). The limited number of values and the specific values that FP4 supports can be leveraged to use three scalar values: 1, 2, and 4, with base values of 0, 1, 2, and 3, as shown in column 105. Additionally, in accordance with these embodiments, the binary code does not change when converting from FP4 to scaled Integer-5, aside from the implicit bit of 1, which is inserted into the scaled Integer-5 format. No code conversion is required, unlike prior approaches which require pre-conversion into a designated special format for both inputs (e.g., converting the multiplicand into signed Int5 while converting the multiplier into Shifted-2-Int-5 as shown in columns 106-107).

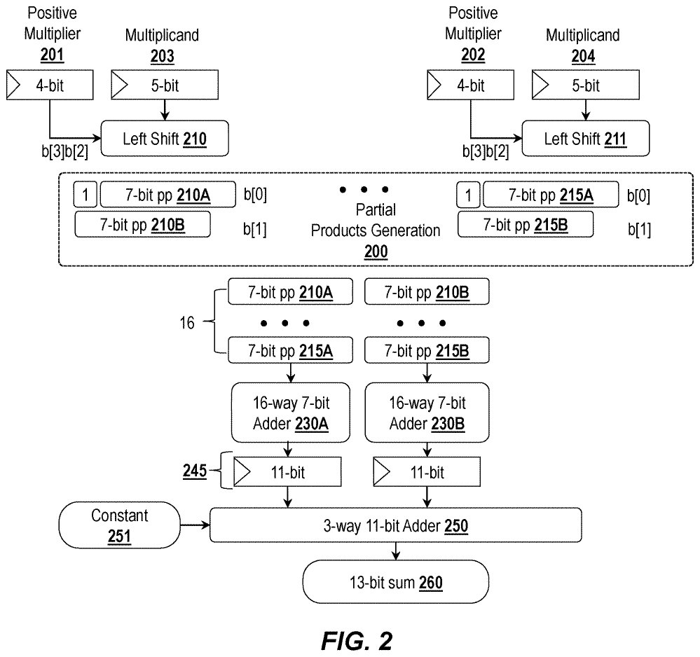

FIG. 2 illustrates an example circuit for performing INT5-based FP4 processing by converting the multiplicand and multiplier as indicated in columns 106-107. Each pair of FP4 input values is converted into one 4-bit always positive multiplier 201-202 and a 5-bit multiplicand 203-204, respectively. In this implementation, when the decimal value of the FP4 value is from 0.0 to 1.5, the three least significant bits of the converted value are the same as the FP4's three least significant values. The fourth bit of the four values are a constant of zero. When the value of the FP4 value is 2.0 or 3.0, the second least significant bit of the FP4 values are inverted and the fourth bits are zero. When the value of the FP4 value is 4.0 or 6.0, one bit of zero is inserted in front of the second least significant bit of the FP4 value.

In this example, the input register space for storing each positive multiplier 201-202 and multiplicand 203-204 is reduced from 10 bits to 9 bits, as the positive indication for the multipliers 201-202 (a bit value of 0) can be dropped. The bits b[3]b[2] of each positive multiplier 201-202 are used by left shift circuits 210-211 to left-shift each respective 5-bit multiplicand 203-204 by a maximum of 2 bits to obtain 7-bit results, each of which is multiplied by each of the two bits of b[1]b[0] of the corresponding positive multiplier 201-202 to generate two corresponding 7-bit partial products 210A-B and 215A-B. While only two sets of partial products 210A-B and 215A-B are shown for simplicity, 16 such partial products may be generated in one implementation (i.e., for 16 corresponding multiplier-multiplicand pairs).

Two 16-way 7-bit adders 230A-B sum the corresponding set of 16 partial products (including partial products 210A, 215A and 210B, 215B) to generate respective 11-bit results stored in registers 245. A corresponding 3-way 11-bit adder 250 adds the 11-bit results and a precomputed constant value 251 to generate a 13-bit sum 260. Consequently, the register space for storing the intermediate results is reduced from 45 bits to 22 bits.

Embodiments of this disclosure further improve the efficiency and reduce the logic required to perform INT5-based FP4 processing. In these implementations, FP4 values are converted into a scaled 5-bit integer format that includes a 2-bit scalar. Due to the limited set of values supported by FP4, these inputs only use three possible scalar values: 1, 2, and 4. When multiplying two of these numbers, their scalars must be multiplied together. Because the inputs can only be 1, 2, or 4, the resulting product can only be one of five specific values: 1, 2, 4, 8, or 16. Consequently, these embodiments use direct decoding or mapping logic to map different combinations of the inputs to the five possible outputs, rather than relying on multipliers and adders.

In some implementations, the direct decoding or mapping is performed based on a set of predetermined Karnaugh maps (K-maps), which represent the digital logic gates required to map the input bits directly to the correct output scalar (Scale 1, Scale 2, Scale 4, Scale 8, or Scale 16). By using direct decoding with K-maps, the multiplication and addition operations are replaced by a simple lookup of the correct output based on the input bits, saving the area and power that would otherwise be consumed.

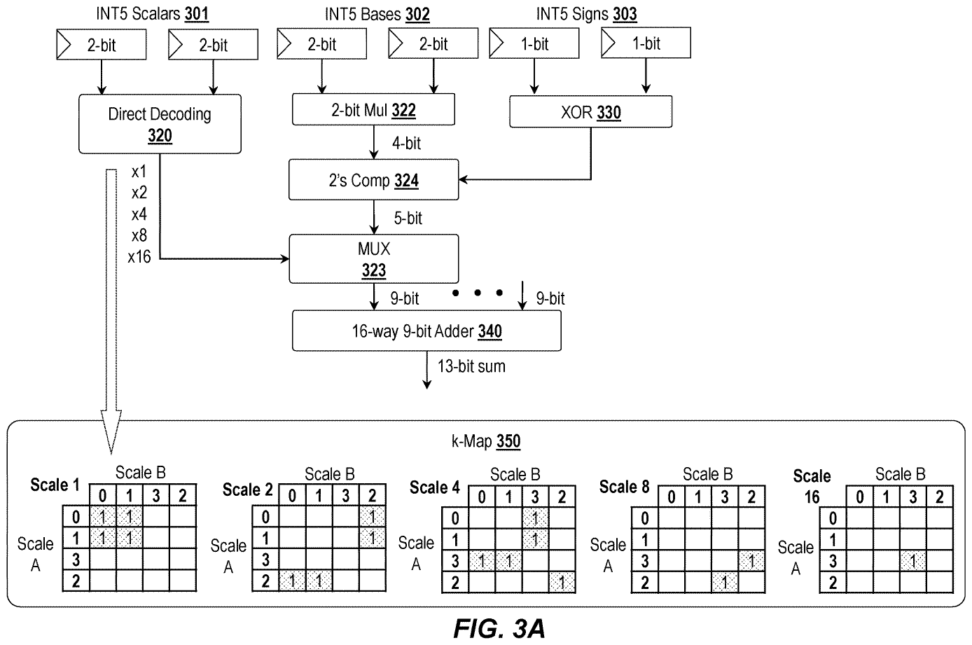

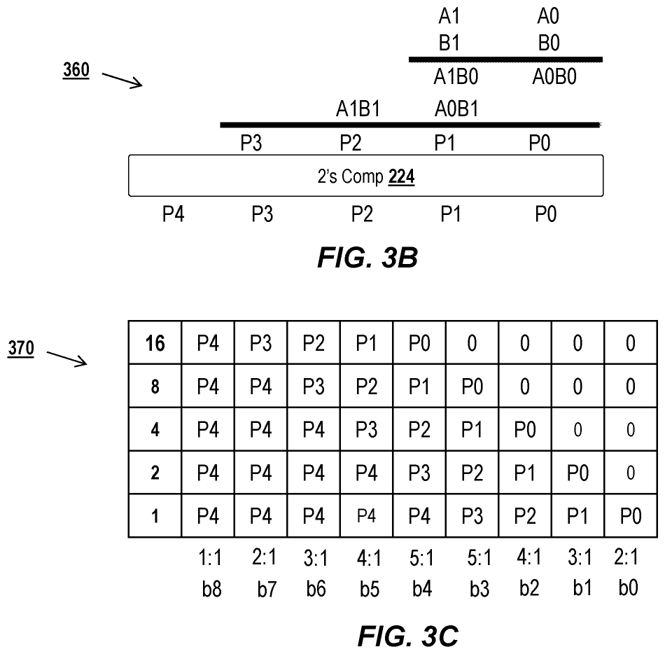

FIG. 3A illustrates an example implementation which does not require pre-conversion into a designated special format for both inputs (e.g., converting the multiplicand into signed Int5 while converting the multiplier into Shifted-2-Int-5 format). The two input scalar values 301, base values 302 (also referred to as mantissas), and signs 303 are stored in registers. A 2-bit multiplier 322 multiplies the pair of INT5 bases 302 to generate a 4-bit value and two's complement logic 324 generates the corresponding 5-bit two's complement value to reduce area and power overhead (relative to generating two's complement values after the MUX 323). Exclusive OR logic 330 generates a resulting sign value based on the two 1-bit sign values 303 in accordance with XOR logic.

Unlike conventional floating-point multiplication and addition that requires finding the sum of exponents of the two inputs and their maximum, the direct decoding circuitry 320 uses the illustrated K-map 350 to directly determine the result, which corresponds to the multiplication of {1,2,4}×{1,2,4}={1,2,4,8,16}. In these embodiments, the pair of FP4 values are converted into a corresponding pair of 2-bit scalar values 301, which can hold four possible binary values: 00, 01, 10, and 11 (0, 1, 2, and 3 in decimal). According to the encoding in Table 100 (FIG. 1), these raw 2-bit hardware codes map to the actual mathematical multipliers: Binary 11 (Decimal 3) translates to the scalar value 4; Binary 10 (Decimal 2) translates to the scalar value 2; Binary 00 or 01 (Decimal 0 or 1) translates to the scalar value 1 (noted as 0x in column 105 of Table 100).

The sequences of 0, 1, 3, 2 along the axes of the K-map 350 tables correspond to the standard Gray code sequence (00, 01, 11, 10). A Gray code sequence is an ordering of the binary numeral system such that two successive values differ in only one bit. This is a sequencing technique used in digital logic design for drawing K-maps to ensure that only one binary bit changes between adjacent columns or rows, as in the tables of the K-map 350. Thus, the axes of the tables (labeled Scale A and Scale B) are indicating the raw 2-bit binary codes being fed into the hardware registers (0, 1, 2, or 3), while the highlighted cells inside the tables represent the logic used to generate the underlying mathematical result of 1 (Scale 1), 2 (Scale 2), 4 (Scale 4), 8 (Scale 8), or 16 (Scale 16).

In the illustrated embodiment, while the direct decoding logic 320 decodes the scalars 301 via the K-map 350, the base integer values 302 are multiplied in parallel by 2-bit multiplier 322 and two's complement logic 324 generates the two's complement of the multiplication result. The table structure 360 in FIG. 3B illustrates this process. In particular, the top half of this table 360 shows two 2-bit base integers (A1, A0 and B1, B0) multiplied together to create a 4-bit product, P3 P2 P1 P0. The two's complement logic 324 converts the 4-bit product into a 5-bit signed integer, P4 P3 P2 P1 P0. The two's complement operation in this embodiment is performed immediately after the 2-bit multiplication to reduce area and power overhead. The final sign bit (P4) may be determined by XOR logic gate 330 that compares the original sign bits of the two inputs.

FIG. 3C illustrates an example MUX logic table 370 to be implemented by the MUX 323 shown in FIG. 3A. In particular, the 5-bit signed integer (P4 P3 P2 P1 P0) output by the two's complement logic 224 and the decoded scalar value (1, 2, 4, 8, or 16) are aligned by the MUX 323 in accordance with the MUX logic table 370, thereby alleviating the need for a traditional barrel shifter.

Each row in the table 370 is associated with one of the decoded scalar values (1, 2, 4, 8, or 16) and each column corresponds to the final 9-bit aligned output sequence (b8 down to b0). In operation, if the decoded scalar value is 1, the integer bits P0-P4 are passed straight into output bits b0-b4 without shifting. If the decoded scalar value is 2, the bits are shifted left by one position, passing into output slots b1-b5; if the value is 4, the bits are shifted left by two positions, passing into output slots b2-b6; if the value is 8, the bits are shifted left by three positions, passing into output slots b3-b7; and if the scalar value is 16, the bits are shifted left by four positions, passing into output slots b4-b8.

Mux sizing values shown beneath the MUX logic table 370 indicates the size of the multiplexing logic required for the corresponding bit position. For example, depending on the scalar row, bit b4 might need to be populated by P0, P1, P2, P3, or P4. Therefore, bit b4 requires a 5:1 MUX. In contrast, the only time b8 is ever used is when the scalar is 16, and it always receives P4. Therefore, only a 1:1 connection is required to generate b8. In other words, the MUX size for each bit position can be defined as an n:1 MUX, where n is the number of potential bit locations from which the output bit may be selected.

Thus, the MUX 323 comprises a MUX network having only those logic gates necessary to perform the required shifts for each bit position (0 to 4 shifts), in contrast to a standard barrel shifter which includes wasted logic capable of calculating all possible shifts up to its bit-width.

In some embodiments, a 16-way 9-bit adder 340 adds the 9-bit result output from the MUX 323 to other 9-bit results generated by parallel instances of the circuitry shown in FIG. 3A to generate a 13-bit sum. In some implementations, the 13-bit sum may then be accumulated with previously calculated values.

In summary, the scaled 5-bit integer embodiments described with respect to FIGS. 3A-C includes several key optimizations over the 5-bit design in FIG. 2. In particular, these embodiments significantly reduce the number of partial products from two to just one, eliminating the need for an added constant. Additionally, these embodiments replace the barrel shifters used for product alignment with more efficient multiplexors, thereby reducing power consumption and area required to perform the operations described herein.

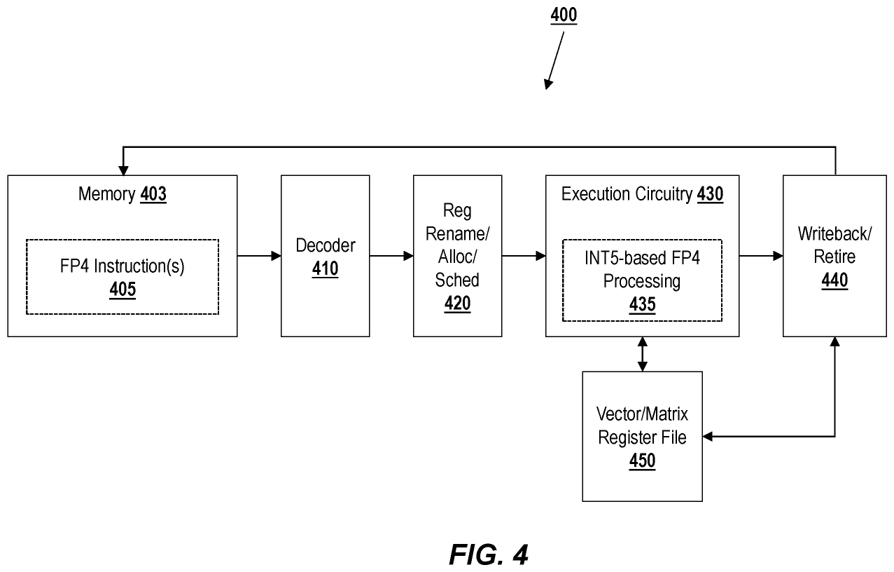

FIG. 4 is a block diagram of an embodiment of a processor or a core of a processor operative to execute an instruction to perform an embodiment of a FP4 instruction 405 stored in storage and/or memory 403. The FP4 instruction 405, for example, may be a dot product instruction specifically designed to perform INT5-based FP4 dot product operations as described herein. Alternatively, the FP4 instruction 405 may not specify an execution mode, but may be executed via INT5-based FP4 dot-product circuitry 435 using the techniques described herein. In either case, the FP4 instruction 405 may represent a macroinstruction, machine code instruction, or other instruction of an instruction set of a processor. The FP4 instruction 405 may have various formats or encodings, including one or more fields for an opcode that at least partially or fully specifies the operation to be performed (e.g., an INT-5 based FP4 dot product) and one or more fields for one or more operands, such as operands usable to identify registers storing source FP4 and/or INT5 data elements. By way of example, and not limitation, the source data elements may comprise FP4 or INT5 data elements of two matrices to be processed via a set of dot product operations as described herein.

Decoder circuitry 410 (e.g., an instruction decoder) may be coupled to receive and decode each FP4 instruction 405 fetched from memory 403 by instruction fetch circuitry (not shown) into one or more lower-level control signals, operations, or decoded instructions (e.g., one or more micro-instructions, micro-operations, micro-code entry points, etc.).

In some examples, register renaming, allocation, and/or scheduling circuitry 420 may provide functionality for one or more of: (1) renaming logical operand values to physical operand values (e.g., a register alias table in some examples); (2) allocating status bits and flags to the decoded instruction; and (3) scheduling the decoded instruction for execution by execution circuitry out of an instruction pool (e.g., using a reservation station in some examples). Vector registers 450 (and/or memory 403) may store source data elements, intermediate data elements, and result data elements of the FP4 instruction 405.

The execution circuitry 430 may be coupled with the decoder circuitry 410, register rename/allocate/scheduler circuitry 420, and the registers/memory 450 and may perform the dot product operations corresponding to the FP4 instruction 405 as described herein. For example, the one or more lower-level control signals, operations, or decoded instructions may be executed by the execution circuitry to control the execution circuitry to perform operations corresponding to the instruction (e.g., operations that are at least partially specified by the opcode of the instruction). Writeback/retire circuitry 440 performs conflict checks prior to retiring results produced by the execution circuitry 430.

In the illustrated implementation, the execution circuitry 430 includes INT5-based FP4 processing circuitry 435 for converting FP4 values to INT5 data elements and performing dot product operations as described herein (see, e.g., FIGS. 3A-C and associated text). In some implementations, the execution circuitry 430 includes INT8-based FP4 dot product circuitry (in place of or in addition to the INT5-based FP4 dot product circuitry) for converting FP4 values to INT8 values using the above-described techniques and performing dot product operations. In these embodiments, the operations may include converting from FP4 to INT5 or INT8, generating sets of partial products, and adding the partial products and constant values to generate dot product results as described herein.

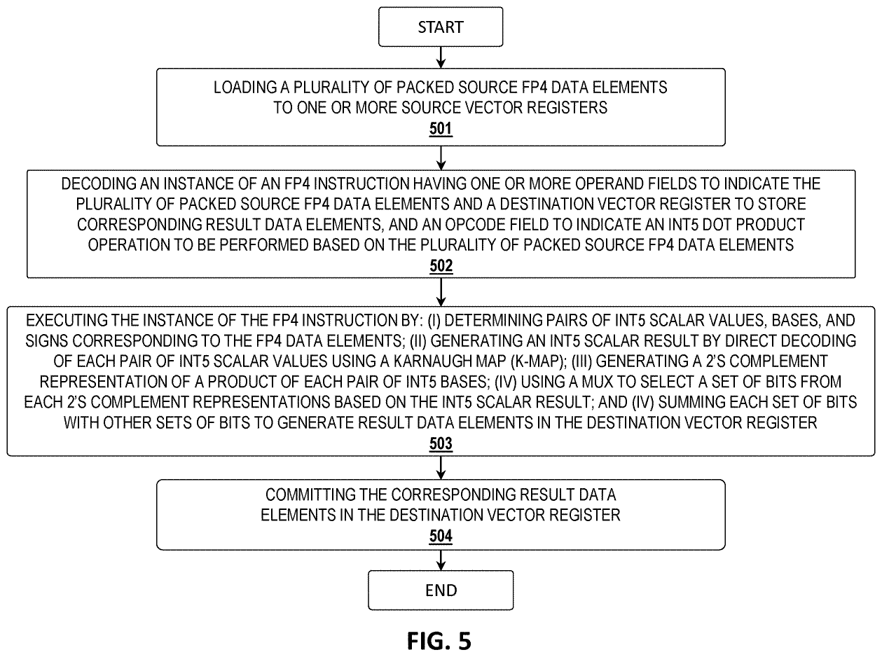

A method in accordance with some implementations is illustrated in FIG. 5. The method may be performed on the various processor, core, and system architectures described herein, but is not necessarily limited to any particular architecture(s).

At 501, a plurality of packed source FP4 data elements are loaded into one or more source vector registers. At 502, an instance of a 4-bit floating-point instruction is decoded, the instruction having one or more operand fields to indicate the plurality of packed source FP4 data elements and a destination vector register to store corresponding result data elements, and an opcode field to indicate an INT5 dot product operation to be performed based on the plurality of packed source FP4 data elements.

At 503, the instance of the instruction is executed by performing a plurality of operations, including: (i) determining pairs of INT5 scalar values, bases, and signs corresponding to the plurality of FP4 data elements; (ii) generating an INT5 scalar result by direct decoding using a Karnaugh map (K-map); (iii) generating a two's complement representation of a product of each pair of INT5 bases; (iv) using a MUX to select a particular set of bits from each two's complement representations based on the INT5 scalar result; and (v) summing each set of bits with other sets of bits to generate result data elements stored in specified locations in the destination vector register loading a plurality of packed source FP4 data elements. As previously described, a Karnaugh map represents the digital logic gates required to map the input bits directly to the correct output scalar (Scale 1, Scale 2, Scale 4, Scale 8, or Scale 16). By using direct decoding with K-maps, multiplication and addition operations can be replaced by a lookup of the correct output based on the input bits, saving the area and power that would otherwise be consumed.

At 504, the corresponding result data elements are committed in the destination vector register.

Thus, the scaled 5-bit integer processing techniques described in this disclosure provide several optimizations over prior designs. For example, these processing techniques significantly reduce the number of partial products from two to just one, eliminating the need for an added constant. Additionally, the techniques in this disclosure replace costly logic such as barrel shifters with more efficient multiplexor implementations, resulting in reduced area and power consumption and improved performance.

Detailed below are descriptions of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a large variety of systems or electronic devices capable of incorporating a processor and/or other execution logic as disclosed herein are generally suitable.

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

Throughout this detailed description, for the purposes of explanation, numerous specific details were set forth to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals - such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

### EXAMPLES

The following are example implementations of different embodiments of the invention.

Example 1. A processor, comprising: one or more registers to store a plurality of source 4-bit floating-point (FP4) data elements; and execution circuitry to execute an instruction having fields to indicate a plurality of pairs of source FP4 data elements on which to perform dot product operations, the execution circuitry to determine pairs of INT5 scalar values, INT5 bases, and INT5 signs corresponding to the pairs of FP4 data elements, the execution circuitry comprising: decoding circuitry to perform direct decoding of each pair of INT5 scalar values in accordance with a Karnaugh map (K-map) to generate a corresponding INT5 scalar result; a multiplier to multiply each corresponding pair of INT5 bases circuitry to generate a base product; two's complement circuitry to generate a two's complement representation of the base product, the two's complement representation comprising a plurality of result bits; and a multiplexor network to select a set of the result bits based on the corresponding INT5 scalar result, the set of the result bits comprising a dot-product result.

Example 2. The processor of Example 1, wherein the execution circuitry includes conversion logic to convert the plurality of pairs of source FP4 data elements to corresponding pairs of INT5 scalar values, INT5 bases, and INT5 signs.

Example 3. The processor of Example 2, wherein the INT5 scalar values comprise 2-bit scalar values, the INT5 bases comprise 2-bit base values, and the INT5 sign values comprise 1-bit sign values.

Example 4. The processor of Example 1, wherein the K-map comprises a plurality of data structures, each data structure corresponding to one of a plurality of potential INT5 scalar results and indicating corresponding pairs of INT5 scalar values.

Example 5. The processor of Example 4, wherein when the INT5 scalar values comprise 2-bit scalar values, the plurality of data structure include a first data structure associated with an INT5 scalar result of 1, a second data structure associated with an INT5 scalar result of 2, a third data structure associated with an INT5 scalar result of 4, a fourth data structure associated with an INT5 scalar result of 8, and a fifth data structure associated with an INT5 scalar result of 16.

Example 6. The processor of Example 5, wherein the multiplexor network comprises a plurality of multiplexors, each multiplexor configured to select a corresponding result bit of the set of result bits based on the corresponding INT5 scalar result.

Example 7. The processor of Example 6, wherein the plurality of multiplexors include multiplexors having different multiplexor sizes, wherein an n:1 multiplexor size is configured for each bit position of the set of result bits, where n is a number of potential bit sources from which a corresponding bit can be selected for the bit position.

Example 8. A non-transitory machine-readable medium having program code stored thereon which, when executed by one or more processors, causes the one or more processors to perform operations, comprising: loading a plurality of source 4-bit floating-point (FP4) data elements in one or more registers; executing an instruction having fields to indicate a plurality of pairs of source FP4 data elements on which to perform dot product operations, the execution circuitry to determine pairs of INT5 scalar values, INT5 bases, and INT5 signs corresponding to the pairs of FP4 data elements; performing direct decoding of each pair of INT5 scalar values in accordance with a Karnaugh map (K-map) to generate a corresponding INT5 scalar result; multiplying each corresponding pair of INT5 bases circuitry to generate a base product; generating a two's complement representation of the base product, the two's complement representation comprising a plurality of result bits; and selecting, by a multiplexor network, a set of the result bits based on the corresponding INT5 scalar result, the set of the result bits comprising a dot-product result.

Example 9. The machine-readable medium of Example 8, further comprising program code to cause the one or more processors to perform the operations of: converting the plurality of pairs of source FP4 data elements to corresponding pairs of INT5 scalar values, INT5 bases, and INT5 signs.

Example 10. The machine-readable medium of Example 9, wherein the INT5 scalar values comprise 2-bit scalar values, the INT5 bases comprise 2-bit base values, and the INT5 sign values comprise 1-bit sign values.

Example 11. The machine-readable medium of Example 8, wherein the K-map comprises a plurality of data structures, each data structure corresponding to one of a plurality of potential INT5 scalar results and indicating corresponding pairs of INT5 scalar values.

Example 12. The machine-readable medium of Example 11, wherein when the INT5 scalar values comprise 2-bit scalar values, the plurality of data structure include a first data structure associated with an INT5 scalar result of 1, a second data structure associated with an INT5 scalar result of 2, a third data structure associated with an INT5 scalar result of 4, a fourth data structure associated with an INT5 scalar result of 8, and a fifth data structure associated with an INT 5 scalar result of 16.

Example 13. The machine-readable medium of Example 12, wherein the multiplexor network comprises a plurality of multiplexors, each multiplexor configured to select a corresponding result bit of the set of result bits based on the corresponding INT5 scalar result.

Example 14. The machine-readable medium of Example 13, wherein the plurality of multiplexors include multiplexors having different multiplexor sizes, wherein an n:1 multiplexor size is configured for each bit position of the set of result bits, where n is a number of potential bit sources from which a corresponding bit can be selected for the bit position.

Example 15. A method, comprising: loading a plurality of source 4-bit floating-point (FP4) data elements in one or more registers; executing an instruction having fields to indicate a plurality of pairs of source FP4 data elements on which to perform dot product operations, the execution circuitry to determine pairs of INT5 scalar values, INT5 bases, and INT5 signs corresponding to the pairs of FP4 data elements; performing direct decoding of each pair of INT5 scalar values in accordance with a Karnaugh map (K-map) to generate a corresponding INT5 scalar result; multiplying each corresponding pair of INT5 bases circuitry to generate a base product; generating a two's complement representation of the base product, the two's complement representation comprising a plurality of result bits; and selecting, by a multiplexor network, a set of the result bits based on the corresponding INT5 scalar result, the set of the result bits comprising a dot-product result.

Example 16. The method of Example 15, further comprising: converting the plurality of pairs of source FP4 data elements to corresponding pairs of INT5 scalar values, INT5 bases, and INT5 signs.

Example 17. The method of Example 16, wherein the INT5 scalar values comprise 2-bit scalar values, the INT5 bases comprise 2-bit base values, and the INT5 sign values comprise 1-bit sign values.

Example 18. The method of Example 15, wherein the K-map comprises a plurality of data structures, each data structure corresponding to one of a plurality of potential INT5 scalar results and indicating corresponding pairs of INT5 scalar values.

Example 19. The method of Example 18, wherein when the INT5 scalar values comprise 2-bit scalar values, the plurality of data structure include a first data structure associated with an INT5 scalar result of 1, a second data structure associated with an INT5 scalar result of 2, a third data structure associated with an INT 5 scalar result of 4, a fourth data structure associated with an INT5 scalar result of 8, and a fifth data structure associated with an INT5 scalar result of 16.

Example 20. The method of Example 19, wherein the multiplexor network comprises a plurality of multiplexors, each multiplexor configured to select a corresponding result bit of the set of result bits based on the corresponding INT5 scalar result.

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
one or more registers to store a plurality of source 4-bit floating-point (FP4) data elements; and
execution circuitry to execute an instruction having fields to indicate a plurality of pairs of source FP4 data elements on which to perform dot product operations, the execution circuitry to determine pairs of INT5 scalar values, INT5 bases, and INT5 signs corresponding to the pairs of FP4 data elements, the execution circuitry comprising:
decoding circuitry to perform decoding of each pair of INT5 scalar values in accordance with a map comprising a reduced set of logic gates configured to map each INT5 scalar value directly to generate a corresponding INT5 scalar result;
a multiplier to multiply each corresponding pair of INT5 bases circuitry to generate a base product;
two's complement circuitry to generate a two's complement representation of the base product, the two's complement representation comprising a plurality of result bits; and
a multiplexor network to select a set of the result bits based on the corresponding INT5 scalar result, the set of the result bits comprising a dot-product result.

2. The processor of claim 1, wherein the execution circuitry includes circuitry to convert the plurality of pairs of source FP4 data elements to corresponding pairs of INT5 scalar values, INT5 bases, and INT5 signs.

3. The processor of claim 2, wherein the INT5 scalar values comprise 2-bit scalar values, the INT5 bases comprise 2-bit base values, and the INT5 sign values comprise 1-bit sign values.

4. The processor of claim 3, wherein the reduced set of logic gates comprise a first set of logic gates associated with an INT5 scalar result of 1, a second set of logic gates associated with an INT5 scalar result of 2, a third set of logic gates associated with an INT5 scalar result of 4, a fourth set of logic gates associated with an INT5 scalar result of 8, and a fifth set of logic gates associated with an INT5 scalar result of 16.

5. The processor of claim 4, wherein the multiplexor network comprises a plurality of multiplexors, each multiplexor configured to select a corresponding result bit of the set of result bits based on the corresponding INT5 scalar result.

6. The processor of claim 5, wherein the plurality of multiplexors include multiplexors having different multiplexor sizes, wherein an n:1 multiplexor size is configured for each bit position of the set of result bits, where n is a number of potential bit sources from which a corresponding bit can be selected for the bit position.

7. The processor of claim 1, wherein the reduced set of logic gates comprises a minimized or optimized set of logic gates generated by a Karnaugh map (K-map).

8. The processor of claim 7, wherein the K-map comprises a plurality of data structures, each data structure corresponding to one of a plurality of potential INT5 scalar results and indicating corresponding pairs of INT5 scalar values.

9. A non-transitory machine-readable medium having program code stored thereon which, when executed by one or more processors, causes the one or more processors to perform operations, comprising:
loading a plurality of source 4-bit floating-point (FP4) data elements in one or more registers;
determining pairs of INT5 scalar values, INT5 bases, and INT5 signs corresponding to pairs of the source FP4 data elements;
performing decoding of each pair of INT5 scalar values in accordance with a map comprising a reduced set of logic gates configured to map each INT5 scalar value directly to generate a corresponding INT5 scalar result;
multiplying each corresponding pair of INT5 bases circuitry to generate a base product;
generating a two's complement representation of the base product, the two's complement representation comprising a plurality of result bits; and
selecting, by a multiplexor network, a set of the result bits based on the corresponding INT5 scalar result, the set of the result bits comprising a dot-product result.

10. The machine-readable medium of claim 9, further comprising program code to cause the one or more processors to perform the operations of:
converting the plurality of pairs of source FP4 data elements to corresponding pairs of INT5 scalar values, INT5 bases, and INT5 signs.

11. The machine-readable medium of claim 10, wherein the INT5 scalar values comprise 2-bit scalar values, the INT5 bases comprise 2-bit base values, and the INT5 sign values comprise 1-bit sign values.

12. The machine-readable medium of claim 11, wherein the reduced set of logic gates comprise a first set of logic gates associated with an INT5 scalar result of 1, a second set of logic gates associated with an INT5 scalar result of 2, a third set of logic gates associated with an INT5 scalar result of 4, a fourth set of logic gates associated with an INT5 scalar result of 8, and a fifth set of logic gates associated with an INT5 scalar result of 16.

13. The machine-readable medium of claim 12, wherein the multiplexor network comprises a plurality of multiplexors, each multiplexor configured to select a corresponding result bit of the set of result bits based on the corresponding INT5 scalar result.

14. The machine-readable medium of claim 13, wherein the plurality of multiplexors include multiplexors having different multiplexor sizes, wherein an n:1 multiplexor size is configured for each bit position of the set of result bits, where n is a number of potential bit sources from which a corresponding bit can be selected for the bit position.

15. The processor of claim 9, wherein the reduced set of logic gates comprises a minimized or optimized set of logic gates generated by a Karnaugh map (K-map).

16. The machine-readable medium of claim 9, wherein the K-map comprises a plurality of data structures, each data structure corresponding to one of a plurality of potential INT5 scalar results and indicating corresponding pairs of INT5 scalar values.

17. A method, comprising:
loading a plurality of source 4-bit floating-point (FP4) data elements in one or more registers;
determining pairs of INT5 scalar values, INT5 bases, and INT5 signs corresponding to pairs of the source FP4 data elements;
performing decoding of each pair of INT5 scalar values in accordance with a map comprising a reduced set of logic gates configured to map each INT5 scalar value directly to generate a corresponding INT5 scalar result;
multiplying each corresponding pair of INT5 bases circuitry to generate a base product;
generating a two's complement representation of the base product, the two's complement representation comprising a plurality of result bits; and
selecting, by a multiplexor network, a set of the result bits based on the corresponding INT5 scalar result, the set of the result bits comprising a dot-product result.

18. The method of claim 17, further comprising:
converting the plurality of pairs of source FP4 data elements to corresponding pairs of INT5 scalar values, INT5 bases, and INT5 signs.

19. The method of claim 18, wherein the INT5 scalar values comprise 2-bit scalar values, the INT5 bases comprise 2-bit base values, and the INT5 sign values comprise 1-bit sign values.

20. The method of claim 18, wherein the K-map comprises a plurality of data structures, each data structure corresponding to one of a plurality of potential INT5 scalar results and indicating corresponding pairs of INT5 scalar values.
